(19) United States
(12) Patent Application Publication
(10) Pub. No.: US 2018/0147744 A1
(43) Pub. Date: May 31, 2018

(54) POCKET FORMING MEMBER

(71) Applicant: Brian Sullivan, Des Moines, IA (US)

(72) Inventor: Brian Sullivan, Des Moines, IA (US)

(21) Appl. No.: 15/825,707

(22) Filed: Nov. 29, 2017

Related U.S. Application Data
(60) Provisional application No. 62/427,545, filed on Nov. 29, 2016.

(51) Int. Cl. B28B 7/16

(52) U.S. Cl. CPC B28B 7/16

(57) ABSTRACT

A pocket forming member having a support body with one or more slots in communication with a slot extension. A hook, adapted to hold a form flush, is connected to the support body. The hook has a first vertical portion, a horizontal portion, and a second vertical portion. The hook can be adjustable.

### CROSS REFERENCE TO RELATED APPLICATION

This application claims the benefit of U.S. Provisional Application No. 62/427,545 filed Nov. 29, 2016.

### BACKGROUND OF THE INVENTION

This invention is directed to a pocket forming member for use in pouring concrete and more particularly to a pocket forming member that is easily attached to a form and more particularly to a metal form.

Pocket forming members are known in the art. In particular, a pocket forming member is attached to the side of a form that frames an area where a slab of concrete is to be poured. The concrete is poured in the area over the pocket forming device and when removed forms a pocket in the concrete slab. A pocket plate is then partially inserted into the pocket and an adjacent slab is poured over the exposed portion of the pocket plate. The pocket plate provides strength and stability to the adjacent slabs.

While useful, current pocket forming members require a nail or screw to attach to a wooden form and a separate tool or measuring device to position the member at the correct height. Not only is this process labor intensive and time consuming, but present pocket forming members are not easily attached to a metal form. Therefore, a need exists in the art for a pocket forming member that addresses these needs.

An objective of the present invention is to provide a pocket forming member that more easily holds a form.

A further objective of the present invention is to provide a pocket forming member that requires less labor and time to use.

These and other objectives will be apparent to one of ordinary skill in the art based upon the following written description, claims and drawings.

### SUMMARY OF THE INVENTION

A pocket forming member having a support body with a top edge, a bottom edge, side edges, a first inner surface, and a second outer surface. Extending through the support body is a slot that is in communication with a slot extension.

Connected to the support body is a hook. Preferably the hook has a first vertical portion, a horizontal portion, and a second vertical portion that are adapted to hold a form flush. The hook can be adjustable both vertically and horizontally.

### BRIEF DESCRIPTION OF THE DRAWINGS

FIG. 1 is a side sectional view of a pocket forming member;

FIG. 2 is a side sectional view of concrete slabs connected by a plate or dowel in a formed pocket;

FIG. 3 is a side view of a pocket forming member with a keyway;

FIG. 4 is a side view of a pocket forming member; and

FIG. 5 is a front view of a pocket forming member.

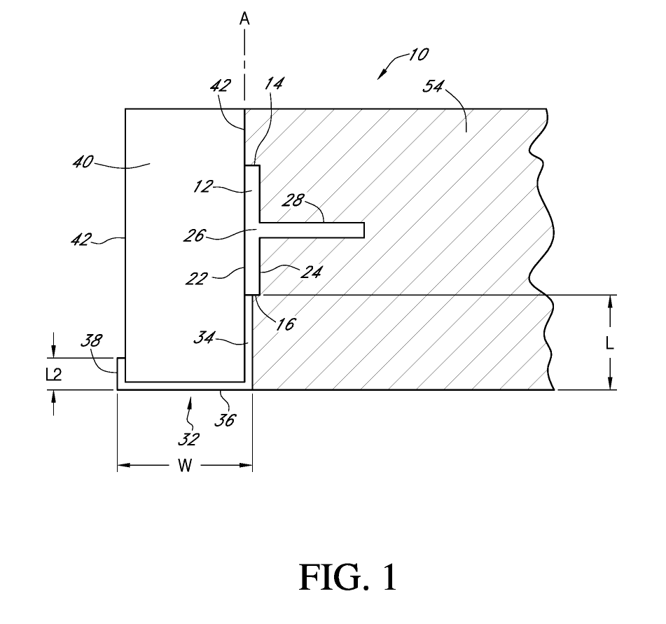

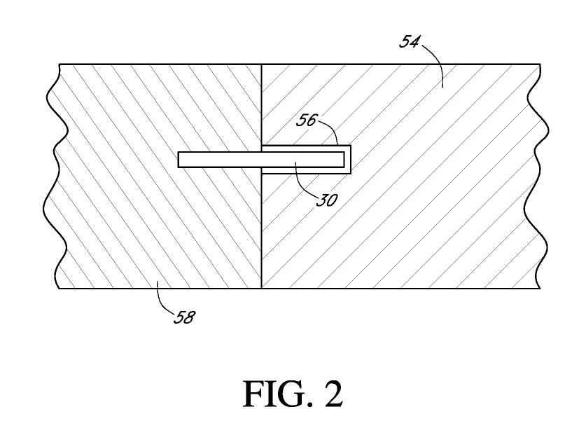

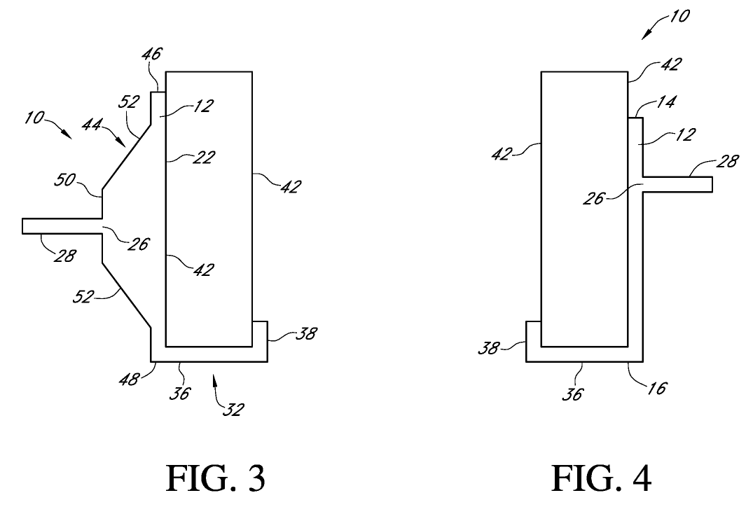

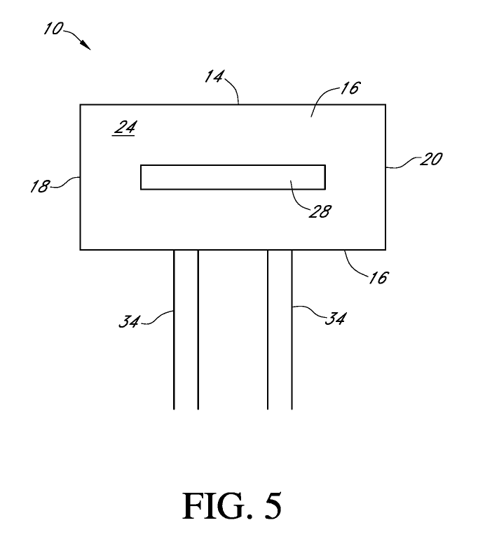

### DETAILED DESCRIPTION OF THE PREFERRED EMBODIMENTS

Referring to the Figures, a pocket forming member 10 includes a support body 12 having a top edge 14, a bottom edge 16, side edges 18 and 20, a first or interior surface 22 and a second or outer surface 24. Extending through the support body 12 is a slot 26 that is in communication with a pocket forming extension 28 that extends outwardly from the second outer surface 24. The width of the slot 26 and the size and shape of the pocket forming extension 28 are configured to receive a pocket plate or dowel 30 of any size and shape selected for a particular application.

In one embodiment, a hook 32 is connected to the support body 12 and preferably is connected to the first inner surface 22. The hook 32 is of any size, shape, or structure and preferably has at least one first vertical portion 34 that extends downwardly from the support body 12. The at least one vertical portion 34 terminates in a horizontal portion 36 that extends away form a vertical plane A of the first inner surface 22. The horizontal portion 36 then terminates in a second vertical portion 38 that extends upwardly from the horizontal portion 36. The dimensions of portions 34, 36, and 38 are dependent upon the form 40 selected for a specific application. The length of the first vertical portion is a length L that positions the pocket forming extension 28 at approximately a midpoint height M of the form 40. The length L2 of the horizontal portion 36 is a length that receives the width of the form 40 while portions 34 and 38 engage sides 42 of the form 40. The length L3 of second vertical portion 38 is a length that holds the support member 12 against a side 42 of form 40 in a generally flush engagement. In one embodiment, the hook 32 is adjustable both horizontally and vertically and/or is adjustably mounted to the support body 12 of the pocket forming member 10. In another embodiment the support body 12 is of one piece construction and includes a hook portion 32 wherein the bottom edge 16 of the support body terminates in a horizontal portion 36 and the horizontal portion terminates in a second vertical portion. Attaching the hook portion 32 to the bottom of form 40 is important for a smooth finish when the top is screed off.

In yet another embodiment the support body 12 has an extended length such as, by example only, about 10 feet. Positioned about one foot apart are a plurality of slots 26 and pocket forming extensions 28. In addition, the support body is configured as a keyway 44. In one example of the keyway 44 the support body 12 has a top portion 46 and a bottom portion 48 that lie generally in vertical plane A and flush against the side 42 of form 40. Extending away from the top portion 46, bottom portion 48, and form 40 toward a center portion 50 are a pair of angled portions 52. The center portion 50 has a slot 26 and a pocket forming extension 28. The bottom portion 48 has a bottom edge 16 that terminates in a second vertical portion 38.

In operation, the form 40 is inserted into the hook portion 32 of the pocket forming member 10. More specifically, the bottom for the form 40 is inserted between the support body 12 and/or the first vertical portion 34 of hook 32 and the second vertical portion 38 so that the bottom of form 40 engages horizontal portion 36. The form 40 with one or more pocket forming members 10 then positioned in a desired location and a first slab 54 of concrete is poured.

Once the first slab 54 has dried, the form 40 and pocket forming members are removed wherein a pocket 56 is formed in the first slab 54. Pocket plates or dowels 30 are then inserted into pockets 56 such that a portion of the plate/dowel is outside of pocket 56. Once inserted a second slab 58 of concrete is poured and left to dry.

What is claimed is:

1. A pocket forming member, comprising:
a support body having a top edge, a bottom edge, side edges, a first inner surface, and a second outer surface;
extending through the support body is a slot that is in communication with a pocket forming extension; and
a hook connected to the support body.

2. The member of claim 1 wherein the hook has at least one vertical portion that extends downwardly from the support body.

3. The member of claim 2 wherein the at least one vertical portion terminates in a horizontal portion that extends away from the first inner surface of the support body.

4. The member of claim 3 wherein the horizontal portion terminates in a second vertical portion that extends upwardly from the horizontal portion.

5. The member of claim 4 wherein the at least one vertical portion, the second vertical portion and the horizontal portion are adapted to hold a form in a flush engagement.

6. The member of claim 2 wherein the at least one vertical portion has a length adapted to reach a midpoint of a form.

7. The member of claim 1 wherein the hook is adjustable.

8. The member of claim 1 wherein the hook has a horizontal portion that extends outwardly from the bottom edge of the support member and terminates in an upwardly extending vertical portion.

9. A pocket forming member, comprising:
a support body having a plurality of slots in communication with pocket forming extensions; and
wherein the support body is configured as a keyway.

10. The member of claim 9 wherein the keyway includes a center portion and a pair of angled portions extending away from the center portion.
